(19) United States
(12) Patent Application Publication
(10) Pub. No.: US 2017/0124545 A1
(43) Pub. Date: May 4, 2017

(54) Hang Jia Self-Ordering Machine

(71) Applicant: Ningdong Xie, Jiangsu (CN)

(72) Inventor: Ningdong Xie, Jiangsu (CN)

(21) Appl. No.: 14/928,419

(22) Filed: Oct. 30, 2015

(51) Int. Cl. G06Q 20/18; G06Q 50/12

(52) U.S. Cl. CPC G06Q 20/18; G06Q 50/12

(57) ABSTRACT

This invention discloses a food-ordering machine and the relevant food-ordering method. The food-ordering machine includes case, touch screen, data processor, currency identifier, card reader, keyboard and change dispenser; The touch screen is controlled by the data processor to display menu information, food-ordering information by the guests, sum of consumption, as well as operation icons of user functions, etc. It will make it convenient for the guests to order foods, pay the bill and replace the seat, etc; while paying the bill, the guests may choose cash payment or payment by card reader. To sum up, this invention, the food-ordering machine, and the method by utilizing the food-ordering machine, may help the guests to order foods, pay the bill, replace table number, etc in a truly self-service manner. In this way, it helps to avoid mistakes and omissions by the waiter while recording the food-ordering information.

Warm Prompt: To ensure the application documents satisfy the requirements of the Patent Law and avoid situations where correction shall be made to the modified information or there may be defects in the modified information that have impacts on the authorization, please leave the changes visible after modification (you can adopt the “Tracked Changes” mode or use colored characters to highlight the changes).

### FIELD OF TECHNOLOGY

This invention relates to a self-service food-ordering equipment and the relevant food-ordering method. It specifically involves a food-ordering machine and the relevant food-ordering method.

### BACKGROUND ART

For the moment, food ordering in restaurants is usually realized by waiters manually. For example, after the guests take their seat, they order foods according to papery menu provided by the restaurant, while the waiter records the food-ordering information with pen or portable terminal equipment. After that, the waiter informs the kitchen of the food-ordering information of the guests, and the kitchen then prepare dishes, beverages and sweets for the guests. No self service of the guests can be realized if food ordering is realized through the waiter. In addition, while recording food-ordering information, the waiter may easily make mistakes or commit omission.

In the following, this invention will be further described, by incorporating the attached Figures and the concrete mode of implementation.

### DESCRIPTION OF INVENTION

Targeting at insufficiency of currently-available technologies, the inventor aims at offering a food-ordering machine which boasts reasonable structure and self service, as well as the food-ordering method by utilizing the food-ordering machine.

In order to realize the aforesaid goal, the following technological schemes are adopted by this invention:

A food-ordering machine which includes case, touch screen, data processor, currency identifier, card reader, keyboard and change dispenser;

From top to bottom, the front surface of the aforesaid case is drilled with the first through hole, second through hole and third through hole; the front surface of the aforesaid case also recesses to form an erecting bed; inside the case, a containing case is installed in the position of the third through hole;

The aforesaid touch screen is installed in the first through hole;

The aforesaid data processor is fixed inside the aforesaid case. The data processor is respectively connected to (signal connection) the aforesaid touch screen, currency identifier, card reader, keyboard and change dispenser;

The aforesaid currency identifier is installed inside the case; inlet of the currency identifier is connected to the aforesaid second through hole;

The aforesaid keyboard is fixed to the aforesaid erecting bed;

The aforesaid card reader is fixed to exterior of the aforesaid case. It is located in one side of the first through hole;

The aforesaid change dispenser is fixed inside the aforesaid case. Outlet of the change dispenser is lined up with the aforesaid third through hole.

Preferential option: The aforesaid change dispenser includes change dispenser of coins and change dispenser of paper money. Both the outlets of change dispenser of coins and change dispenser of paper money are connected to the third through hole.

Preferential option: Bottom of the aforesaid case is equipped with rolling wheels.

Preferential option: An advertisement displayer may also be included. It is installed on top of the case, and is connected to (signal connection) to the aforesaid data processor.

A food-ordering method, which includes:

Food-ordering information will be obtained through the aforesaid touch screen. The food-ordering information will be sent to the aforesaid data processor;

Payment information of the guests will be obtained through the aforesaid currency identifier and/or card reader; the payment information will be sent to the data processor;

Food-ordering information will be obtained by the aforesaid data processor, which will, according to such information, calculate the sum of consumption and arrange for tables. The data processor also generates service information according to the food-ordering information, while the service staff offer services to the guests according to the service information;

The aforesaid data processor will obtain payment information of the aforesaid guests, and identify type of the payment information:

When the payment information relates to the cash payment information of the aforesaid currency identifier, the currency identifier will evaluate the cash value, and compare the cash value to the aforesaid sum of consumption. When the cash value is smaller than the sum of consumption, the currency identifier will continue to obtain cash payment information. When the aforesaid cash value equals to the sum of consumption, payment will be finished successfully; when the aforesaid cash value is larger than the sum of consumption, a signal of change will be sent to the change dispenser, while the payment will be finished;

After obtaining the aforesaid signal of change, the aforesaid change dispenser will automatically spit out relevant money;

If the payment information is obtained through the aforesaid card reader, the card reader will be utilized to obtain card information. The aforesaid keyboard will be utilized to obtain password of the card. After that, whether the aforesaid password relates to the card information will be evaluated. If yes, relevant sum in the card will be deducted to finish the payment; otherwise the information of failure of payment will be given out, and be displayed on the aforesaid touch screen.

Preferential option: If the payment information is cash payment information obtained through the aforesaid currency identifier, the following steps will be included:

The aforesaid data processor will, according to the aforesaid money information, evaluate whether the money collected are legal money. If no, a signal of rejection will be given and be sent to the currency identifier, through which the cash will directly be spat out; if yes, the cash value will be obtained.

Preferential option: If the payment information is the payment information obtained through the aforesaid card reader, the following steps will be included:

The aforesaid data processor will, according to the aforesaid card information, evaluate whether the aforesaid card is legal. If the card is illegal, prompt that the card is illegal will be given, and will be displayed on the touch screen; If the card is legal, the data processor will, according to the card information, evaluate whether balance of the card are greater than or equal to the sum of consumption. If yes, the sum of consumption will automatically be deducted from balance of the card; otherwise the prompt that balance of the card is insufficient will be given, and be displayed on the aforesaid touch screen.

Merits of this invention are:

This invention, the food-ordering machine, includes case, touch screen, data processor, currency identifier, card reader, keyboard and change dispenser; The aforesaid touch screen is controlled by the aforesaid data processor to display menu information, food-ordering information by the guests, sum of consumption, as well as operation icons of user functions, etc. It will make it convenient for the guests to order foods, pay the bill and replace the seat, etc; While paying the bill, the guests may choose cash payment or payment by card reader. When payment by card reader is chosen, the guests may type in password of the card through the aforesaid keyboard; When cash payment is chosen, the data processor will control the change dispenser to spit out changes for the guests, in case the cash paid by the guests is greater than the sum of consumption.

The food-ordering method of this invention is as follows: Food-ordering information will be obtained through the aforesaid touch screen; payment information of the guests will be obtained through the aforesaid currency identifier and/or card reader; After that, the aforesaid data processor will handle the payment according to the aforesaid food-ordering information and payment information. The aforesaid payment information includes cash payment information and card reader payment information, which allow the guests to pay the bill in a self-service manner through this invention, the food-ordering machine, in more than one ways, like cash payment or card reader payment.

To sum up, this invention, the food-ordering machine, and the method by utilizing the food-ordering machine, may help the guests to order foods, pay the bill, replace table number, etc in a truly self-service manner. In this way, it helps to avoid mistakes and omissions by the waiter while recording the food-ordering information.

### DESCRIPTION OF FIGURES

FIG. 1: Structural representation of this invention, the food-ordering machine;

FIG. 2: Schematic diagram of internal structure of this invention, the food-ordering machine;

FIG. 3: Work flow of food-ordering method of this invention, the food-ordering machine.

### SPECIFIC METHOD OF IMPLEMENTATION

### Specific Example of Implementation

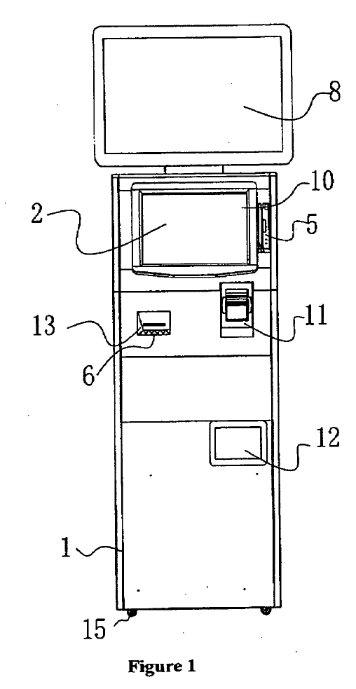

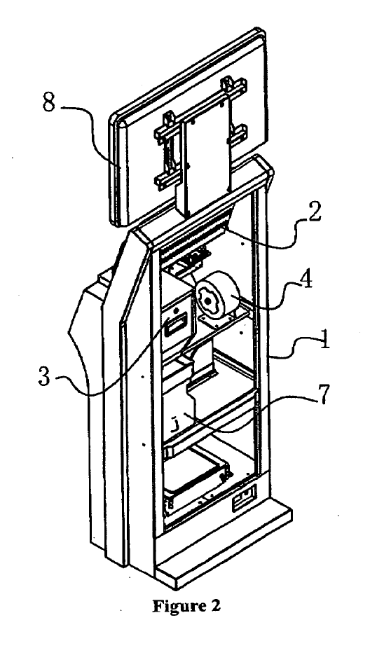

According to FIGS. 1 and 2, the food-ordering machine mentioned in this example includes the case 1, touch screen 2, data processor 3, currency identifier 4, card reader 5, keyboard 6, and change dispenser 7.

The aforesaid easel is hollow. Inside the aforesaid easel equipment like the aforesaid data processor 3, currency identifier 4 and change dispenser 7, etc are installed. From top to bottom, front surface of the aforesaid easel is drilled with the first through hole 10, which is utilized to install touch screen 2, the second through hole 11, which is utilized to collect money, as well as the third through hole 12, which is utilized to spit out money. Front surface of the aforesaid easel also recesses to form an erecting bed 13. The erecting bed 13 is located in one side of the second through hole 11. From top to bottom, rear surface of the easel is drilled with a number of ventilation holes (no indication in the Figures) and bellmouth orifices (no indication in the Figures). Inside the aforesaid easel a containing case is installed in the position of the third through hole 12 (no indication in the Figures).

The aforesaid touch screen 2 is installed in the first through hole 10 of case 1. The aforesaid touch screen 2 is utilized to display menu information, food-ordering information by the guests, sum of consumption, as well as operation icons of user functions, etc. It will allow the guest to order foods, replace table number and pay the bill, etc through the touch screen 2. It may also by utilized to obtain relevant information of operation by the guests, and send such information to the data processor 3 for handling of food ordering, replacement of table number and calculation of the sum of consumption, etc.

The aforesaid data processor 3 is fixed inside the aforesaid case 1. The data processor 3 is respectively connected to (signal connection) the aforesaid touch screen 2, currency identifier 4, card reader 5, keyboard 6 and change dispenser 7. The data processor 3 is utilized to receive food-ordering information of the guests from the touch screen 2 and, according to the food-ordering information, carry out operations like automatic food ordering and replacement of table number; in addition, it may also help the guests to pay the bill by incorporating information of the aforesaid currency identifier 4 or card reader 5.

The aforesaid currency identifier 4 is a technological tool commonly utilized by technologists in this field. The aforesaid currency identifier 4 is installed inside the case 1; inlet of the currency identifier 4 is located in the second through hole 11, and is connected to the aforesaid second through hole 11. It is utilized to collect money from the second through hole 11, and evaluate whether the money is legal, and cash value of legal money, etc, and send such information to the data processor 3.

The aforesaid keyboard is fixed to the aforesaid erecting bed 13. It is utilized for the guests to type in password of the aforesaid card.

The aforesaid card reader 5 is a technological tool commonly utilized by technologists in this field. The aforesaid card reader 5 is fixed to exterior of the aforesaid case 1, and is located in one side of the first through hole 10. The card reader 5 is utilized to obtain the card information of the guests in paying the bill, and send the information to the data processor 3.

The aforesaid money change dispenser 7 is a technological tool commonly utilized by technologists in this field. The aforesaid change dispenser 7 is fixed inside the aforesaid case 1. Outlet of the change dispenser 7 is lined up with the aforesaid third through hole 12. The aforesaid change dispenser 7 includes change dispenser of coins (no indication in the Figures) and change dispenser of paper money (no indication in the Figures). Both the outlets of change dispenser of coins and change dispenser of paper money are connected to the third through hole 12. The aforesaid change dispenser of coin and change dispenser of paper money are connected to the aforesaid data processor 3. When value of money read through the currency identifier 4 is larger than the food-ordering sum, the relevant changes may be returned to the guests through the change dispenser 7. The aforesaid changes may fall into the aforesaid containing case, which can be collected by the guests conveniently.

Preferential option available: It will enable the guests to learn about information of preferential treatment, signboard, activities and other information of the restaurant in a more convenient manner. An advertisement displayer 8 may also be mounted on the food-ordering machine. It is installed on top of the case 1, and is connected to (signal connection) to the aforesaid data processor 3.

Preferential option available: In order to make it convenient for portage of the food-ordering machine, bottom of the easel is equipped with rolling wheels.

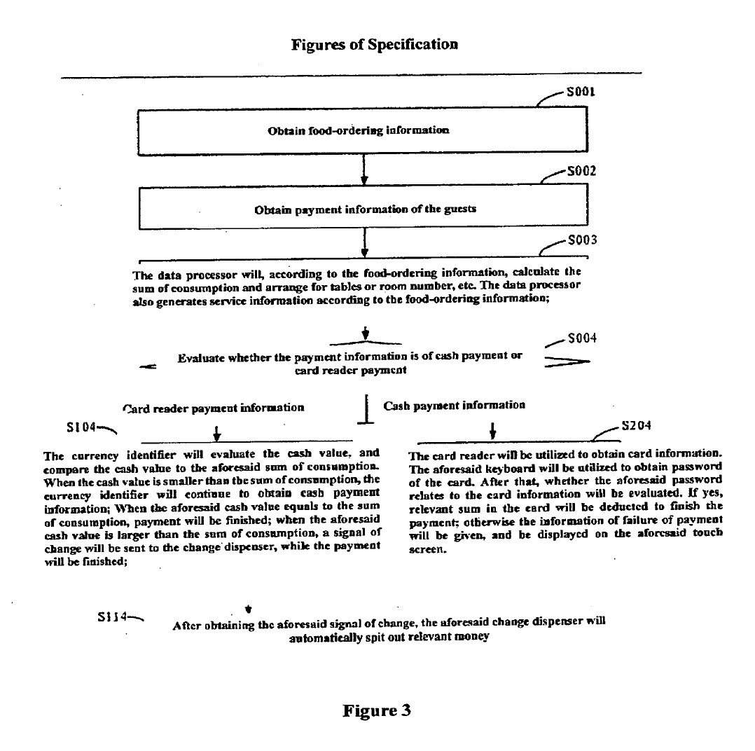

Reference to FIG. 3: This invention also offers a food-ordering method by utilizing the aforesaid food-ordering machine. It includes:

S001 Food-ordering information will be obtained through the aforesaid touch screen. The food-ordering information will be sent to the aforesaid data processor; The aforesaid food-ordering information may include the name, price, quantity, rebate of the foods selected by the guests, as well as the food-ordering time, etc.

S002 Information of payment by the guest will be obtained through the aforesaid currency identifier and/or card reader; the information of payment will be sent to the data processor.

S003 Food-ordering information will be obtained by the aforesaid data processor, which will, according to such information, calculate the sum of consumption and arrange for tables or room number, etc. The data processor also generates service information according to the food-ordering information, while the service staff offer services to the guests according to the service information.

S004 The aforesaid data processor will obtain payment information of the aforesaid guests, and evaluation will be based on such payment information.

S104 When the payment information relates to the cash payment information of the aforesaid currency identifier, the currency identifier will evaluate the cash value, and compare the cash value to the aforesaid sum of consumption. When the cash value is smaller than the sum of consumption, the currency identifier will continue to obtain cash payment information. When the aforesaid cash value equals to the sum of consumption, payment will be finished successfully; when the aforesaid cash value is larger than the sum of consumption, a signal of change will be sent to the change dispenser, while the payment will be finished.

S114 After obtaining the aforesaid signal of change, the aforesaid change dispenser will automatically spit out relevant money.

S204 If the payment information is obtained through the aforesaid card reader, the card reader will be utilized to obtain card information. The aforesaid keyboard will be utilized to obtain password of the card. After that, whether the aforesaid password relates to the card information will be evaluated. If yes, relevant sum in the card will be deducted to finish the payment; Otherwise, the information of failure of payment will be given out, and be displayed on the aforesaid touch screen.

Preferential option available: If the payment information is cash payment information obtained through the aforesaid currency identifier, the following steps will be included:

The aforesaid data processor will, according to the aforesaid money information, evaluate whether the money collected are legal money. If no, a signal of rejection will be given and be sent to the currency identifier, through which the cash will directly be spat out; if yes, the cash value will be obtained.

If the payment information is the payment information obtained through the aforesaid card reader, the following steps shall be included:

The aforesaid data processor will, according to the aforesaid card information, evaluate whether the aforesaid card is legal. If the card is illegal, prompt that the card is illegal will be given, and will be displayed on the touch screen; If the card is legal, the data processor will, according to the card information, evaluate whether balance of the card are greater than or equal to the sum of consumption. If yes, the sum of consumption will automatically be deducted from balance of the card; otherwise the prompt that balance of the card is insufficient will be given, and be displayed on the aforesaid touch screen.

Technologists in this field may, according to the aforesaid technological proposal and conception, work out other types of corresponding change and deformation, while all of these change and deformation shall be within protection scope of Claim of Right of this invention.

1. The food-ordering machine includes case, touch screen, data processor, currency identifier, card reader, keyboard and change dispenser;
From top to bottom, the front surface of the aforesaid case is drilled with the first through hole, second through hole and third through hole; the front surface of the aforesaid case also recesses to form an erecting bed; inside the case, a containing case is installed in the position of the third through hole;
The aforesaid touch screen is installed in the first through hole;
The aforesaid data processor is fixed inside the aforesaid case. The data processor is respectively connected to (signal connection) the aforesaid touch screen, currency identifier, card reader, keyboard and change dispenser;
The aforesaid currency identifier is installed inside the case; inlet of the currency identifier is connected to the aforesaid second through hole;
The aforesaid keyboard is fixed to the aforesaid erecting bed;
The aforesaid card reader is fixed to exterior of the aforesaid case. It is located in one side of the first through hole;
The aforesaid change dispenser is fixed inside the aforesaid case. Outlet of the change dispenser is lined up with the aforesaid third through hole.

2. The food-ordering machine described in claim of Right 1 has the following characteristics: The aforesaid change dispenser includes change dispenser of coins and change dispenser of paper money. Both the outlets of change dispenser of coins and change dispenser of paper money are connected to the third through hole.

3. The food-ordering machine described in claim of Right 1 has the following characteristics: Bottom of the aforesaid case is equipped with rolling wheels.

4. The food-ordering machine described in claim of Right 1, 2 or 3 has the following characteristics: An advertisement displayer may also be included. It is installed on top of the case, and is connected to (signal connection) to the aforesaid data processor.

5. A food-ordering method by utilizing the food-ordering machine described in any item of claim of Right 1-4, which has the following characteristics:
Food-ordering information will be obtained through the aforesaid touch screen. The food-ordering information will be sent to the aforesaid data processor;
Information of payment by the guest will be obtained through the aforesaid currency identifier and/or card reader; the information of payment will be sent to the data processor;
Food-ordering information will be obtained by the aforesaid data processor, which will, according to such information, calculate the sum of consumption and arrange for tables. The data processor also generates service information according to the food-ordering information, while the service staff offer services to the guests according to the service information;
The aforesaid data processor will obtain payment information of the aforesaid guests, and identify type of the payment information:
When the payment information relates to the cash payment information of the aforesaid currency identifier, the currency identifier will evaluate the cash value, and compare the cash value to the aforesaid sum of consumption. When the cash value is smaller than the sum of consumption, the currency identifier will continue to obtain cash payment information. When the aforesaid cash value equals to the sum of consumption, payment will be finished successfully; when the aforesaid cash value is larger than the sum of consumption, a signal of change will be sent to the change dispenser, while the payment will be finished;
After obtaining the aforesaid signal of change, the aforesaid change dispenser will automatically spit out relevant money;
If the payment information is obtained through the aforesaid card reader, the card reader will be utilized to obtain card information. The aforesaid keyboard will be utilized to obtain password of the card. After that, whether the aforesaid password relates to the card information will be evaluated. If yes, relevant sum in the card will be deducted to finish the payment; otherwise the information of failure of payment will be given out, and be displayed on the aforesaid touch screen.

6. The food-ordering method described in claim of Right 5 has the following characteristics: If the payment information is cash payment information obtained through the aforesaid currency identifier, the following steps will be included:
The aforesaid data processor will, according to the aforesaid money information, evaluate whether the money collected are legal money. If no, a signal of rejection will be given and be sent to the currency identifier, through which the cash will directly be spat out; if yes, the cash value will be obtained.

7. The food-ordering method described in claim of Right 5 has the following characteristics: If the payment information is the payment information obtained through the aforesaid card reader, the following steps shall be included:
The aforesaid data processor will, according to the aforesaid card information, evaluate whether the aforesaid card is legal. If the card is illegal, prompt that the card is illegal will be given, and will be displayed on the touch screen; If the card is legal, the data processor will, according to the card information, evaluate whether balance of the card are greater than or equal to the sum of consumption. If yes, the sum of consumption will automatically be deducted from balance of the card; otherwise the prompt that balance of the card is insufficient will be given, and be displayed on the aforesaid touch screen.
